(19) United States
(12) Patent Application Publication
(10) Pub. No.: US 2009/0063258 A1
(43) Pub. Date: Mar. 5, 2009

(54) Engineered Labor Standards ("ELS") Management

(76) Inventors: Juergen Mueller, Kandel (DE); Christian Reinhardt, Mannheim (DE); Markus Puchta, Regensburg (DE); Ulrike Janhoefer, Heidelberg (DE); Wassilli Sabelfeld, Koenigs Wusterhausen (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/847,254

(22) Filed: Aug. 29, 2007

(51) Int. Cl. G06Q 99/00

(52) U.S. Cl. 705/11

(57) ABSTRACT

An Engineered Labor Standards (“ELS”) scheduling system prepares preliminary estimates of task durations based on a subset of the conditions affecting task duration, then later prepares adjusted estimates when more information about the conditions becomes available. The actual time a resource spends performing the task is measured, and the estimates and measurements are stored in a database.

### FIELD

The invention relates to estimating and measuring worker productivity. More specifically, the invention relates to collecting data for improving the accuracy of task duration estimates and assessing the likely benefits of possible investments in equipment and/or training.

### BACKGROUND

Many businesses' value propositions depend on the efficient performance of many similar (but often non-identical) tasks. Managers must be vigilant in monitoring operations so that opportunities to streamline procedures are not missed (and conversely, so that economically unfavorable “improvements” are not adopted). In the past, relatively coarse-grained information was adequate for monitoring and planning, but as competition intensifies and profit margins shrink, factors that were once too insignificant to justify consideration may become crucial to the success of an enterprise.

Strictly regular operations (e.g. pick-and-place and similar assembly-line tasks) have been studied carefully, and many effective optimization techniques are known. In addition, common sub-tasks of a diverse workload can be identified and addressed. For example, a commercial enterprise that operates thousands of pharmacies may discover that something as simple as standardizing the location of a stapler within its dispensaries can save hundreds of thousands of dollars each year. These examples fall within the boundaries of traditional Engineered Labor Standards (“ELS”) methods. However, there is a class of tasks that are too irregular for traditional ELS optimization approaches, yet similar enough that there would seem to be improvement opportunities available. These tasks can often be identified by the existence of workers who are particularly good at doing them (relative to their co-workers of similar experience). Tools are needed to determine why the good workers are good—both so that those workers can be rewarded for their skill, and so that other workers can be trained to be more like the best.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a sample environment where an embodiment of the invention can be used.

FIG. 2 is a flowchart outlining operations according to an embodiment of the invention.

FIGS. 3A and 3B show factors that may be considered in making preliminary and adjusted task duration estimates, respectively.

FIG. 4 is a flow chart outlining operations of a task-centric scheduling system according to one embodiment of the invention.

FIG. 5 is a flow chart outlining operations of a resource-centric scheduling system according to another embodiment of the invention.

FIG. 6 is a logical block diagram of elements that are considered in an Engineered Labor Standards (“ELS”) scheduling system that implements an embodiment of the invention.

FIG. 7 is a flow chart of another embodiment of the invention.

### DETAILED DESCRIPTION

Embodiments of the invention produce preliminary estimates of task durations based on partial information available at a first time, then refine the estimates as additional information becomes available. Finally, the actual duration of a task is measured when the task is performed, and the estimates and measurement are used to improve future estimates (and for other purposes discussed below). Warehouse stocking and retrieval operations will be used to provide a practical framework for describing the methods, but it should be understood that any sort of work that involves more than one person, more than one type of equipment, or more than one specific task, can also be optimized by the procedures described herein. In the following discussion, a “resource” is specifically defined to be a worker either with or without equipment to perform a task. (I.e., a worker alone can perform some tasks, while equipment such as a fork lift, ladder or crane may be necessary for a worker to perform other tasks. Equipment alone is not a resource, unless it is automated or robotic equipment that can be set to perform a task autonomously.)

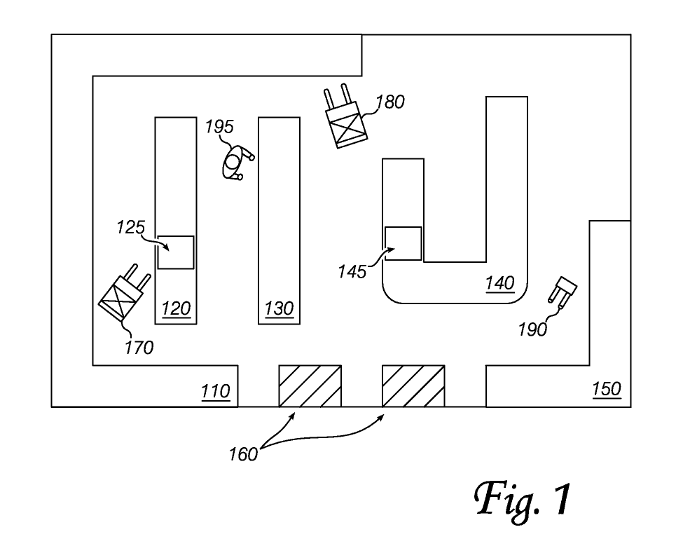

FIG. 1 shows a plan view of a sample warehouse and factory floor. Elements 110, 120 and 130 indicate stock shelves, which hold supplies for manufacturing activities occurring at assembly line 140. Finished products are stored at 150. Two receiving/shipping docks are shown at 160. Materials are moved about the warehouse and floor by equipment and workers such as fork lifts 170 and 180, hand truck 190, and worker 195. Embodiments of the invention help plan and measure tasks such as moving an item from a stock location 125 to a work location 145.

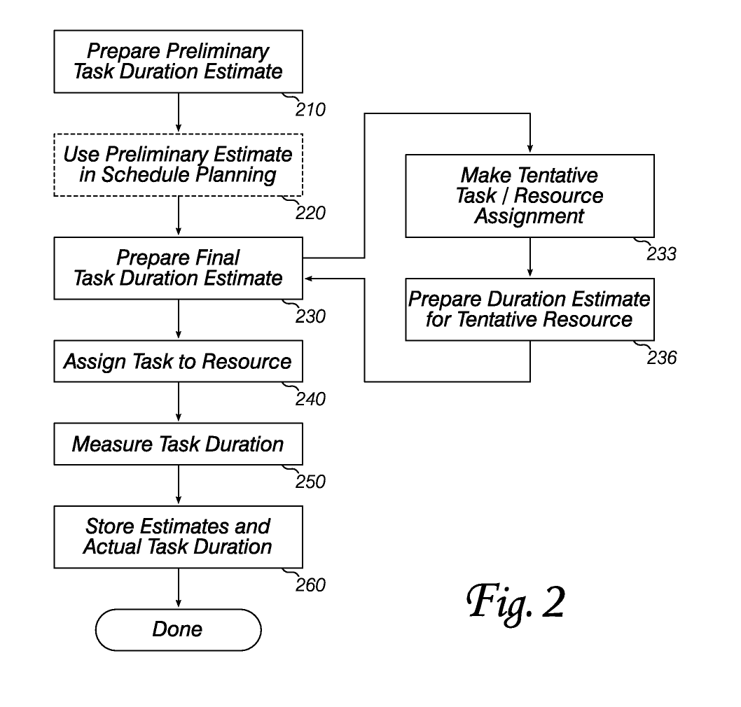

FIG. 2 is a flow chart outlining operations according to an embodiment of the invention. First, a preliminary estimate of a task duration (“planned time”) is prepared (210). The estimate may take into account details known at the time of the estimate. For example, if the task is to move an item from a stock location to a work location (as mentioned in reference to FIG. 1), then the planned time may consider the distance between the origin and destination, the weight of the item, the speed of a conveyance, loading and unloading times, and so on. The preliminary estimate necessarily omits some factors that will not be known until the task is actually executed—for example, the particular resource that will perform the task, the distance the resource must travel to begin the task, etc. These factors may be important—a unique characteristic of a resource such as its speed or a situational characteristic such as the resource's location before beginning the task—but they cannot be determined until it is time to perform the task, so they must be omitted from the estimate. The preliminary estimate may be used in gross schedule planning (220) and to forecast derivative quantities such as production capacity, resource requirements, and the like.

Later, when it is time to perform the task, a final task duration estimate (“adjusted planned time”) is prepared (230). The final estimate may incorporate any or all information available at the time. In particular, the final estimate may incorporate information that was not available when the preliminary estimate was made. For example, when the final planned time is computed, a workflow system may have information about the locations of resources that could perform the task (e.g. fork lifts and their operators; or workers with or without manual tools). In addition, the system may be aware of circumstances or activities that may affect the planned task. For example, an earlier-dispatched task may have resulted in blockage of the best route for this task, so the system may adjust the final estimate to account for the use of a slower, alternate route.

The task is assigned to a resource (240) and the task's actual duration is measured (250). The estimates and actual duration are stored in a database (260) for subsequent analysis. Although the flow chart shows the adjusted planned time being estimated before the task is assigned to a resource, implementers will recognize that the adjusted planned time often depends on particular characteristics and conditions of a specific resource. Consequently, the operations represented by blocks 230 and 240 of the flow chart may be more intricately interconnected, as shown by blocks 233 and 236: in some embodiments, a tentative assignment between the task and a resource that could perform the task is made (233) and a final task duration estimate for that resource is prepared (236). If other resources could also perform the task, additional tentative assignments and corresponding final task duration estimates may be made, before the task is finally assigned to one of the resources (240).

A wide array of factors may cause the planned time to be different from the adjusted planned time. In the context of warehouse operations (the specific application considered here) preliminary time estimates may be made without considering factors such as the end position of a resource's previous task, interference from concurrent tasks, or the possibility of re-sequencing several tasks to achieve greater efficiency. Of course, preliminary estimates could attempt to account for all known factors (e.g. by planning every task, in sequence, for every resource, for an extended period such as an hour or a day). However, such extended plans lack resiliency: if any assumption proves incorrect, any operational error occurs, or any resource is unavailable for some reason, the extended plan can quickly become useless, and the system must resort to on-the-fly scheduling. Also, extrinsic events such as the arrival of a transport delivering supplies or picking up a shipment often cannot be predicted with any accuracy. Task-by-task planning (or planning of relatively short task sequences) produces more robust schedules, the accuracy of which can be improved by statistical analysis of the adjusted plan times and measured task durations.

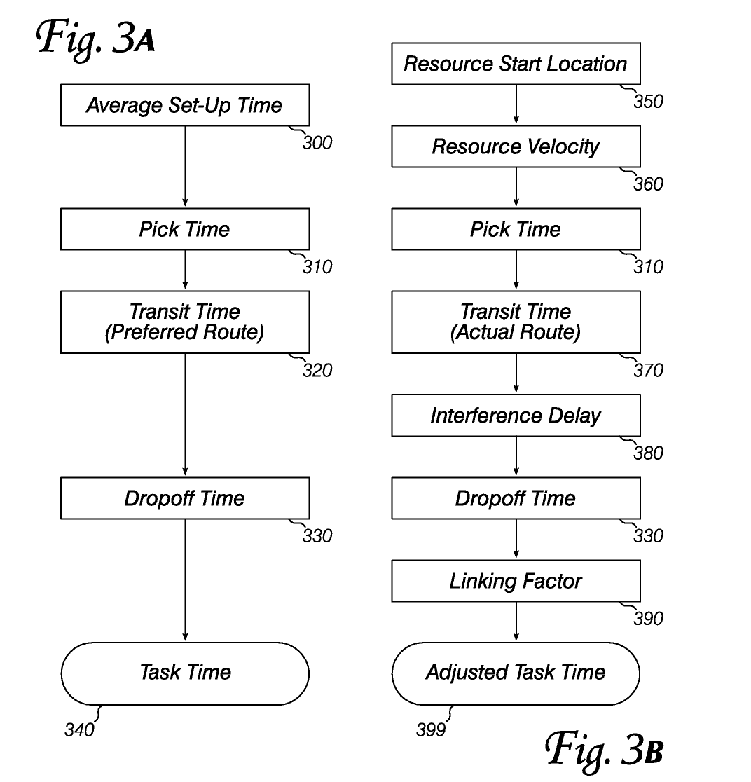

FIGS. 3A and 3B show a possible correspondence between factors considered in making a preliminary task duration estimate, and factors considered in making a final task duration estimate. For the preliminary estimate, an average set-up time (300) is chosen. A pick time (310), transit time via a preferred route (and assuming an average velocity) (320), and dropoff time (330) are added to compute the task time (340). When additional information about the task and resource become available (e.g. when it is time to assign the task to a resource), the adjusted task time 399 is computed, as indicated in FIG. 3B. The resource's start location (350) and velocity (360) substitute for the average set-up time (310) used in FIG. 3A. The pick time 310 and dropoff time 330 may be the same, but the transit time (370) may differ because, for example, an alternate route must be taken, or because the actual resource moves faster or slower than the average velocity assumed when preparing the preliminary estimate. Also, execution of the task may be delayed by interference with a concurrent task (380). In addition, a “linking factor” 390 may be added to account for a benefit or detriment of assigning this task to the resource. Linking factors may favor a task that leaves the resource close to the start location of a subsequent task, or may disfavor an assignment that causes a slow-moving resource to travel a great distance. As FIGS. 3A and 3B show, the preliminary task time is computed based on a subset of the conditions that affect the adjusted task time.

In some embodiments, a key distinguishing factor between preliminary and final task duration estimates is whether information about a material factor affecting task duration is available when the estimate is made. A preliminary estimate is made before such material information is available, while a final estimate is made after the information becomes available. Often, the material factor is a circumstance that cannot be accurately predicted in advance. For example, the arrival of a supply shipment may occupy some resources that were expected to be available to perform a task, or a worker may take a shorter or longer break than usual, altering the set of resources to which a task might later be assigned. Operations in some environments are affected by a large number of time-dependent factors, so a preliminary estimate necessarily incorporates many “best guesses,” which are resolved later when task-execution circumstances become clear.

After a task is assigned to a resource and executed, the adjusted planned time and actual (measured) task durations can be used for a number of business purposes. First, the data can support a demonstrably fairer worker productivity analysis. Instead of a gross metric such as “number of tasks completed” or “hours worked,” each worker can be evaluated according to his performance on the actual tasks assigned. Thus, a worker using less-capable equipment, or one whose task was impeded by other activity, will not be penalized; while a worker who happens to receive a sequence of easily-completed tasks will not receive an unfairly high grade.

Second, the preliminary and final task duration estimates, along with historical actual task durations, can be used in performing operational simulations. For example, starting with a representative set of tasks for a period of time, with durations estimated by preliminary methods, simulations based on previously-measured task durations can be tested to find worker and resource allocations that are robust in the face of plausible (simulated) interferences such as equipment malfunctions, transport arrivals and departures, and inter-resource task schedule skew. Simulations are important because, while absolute task performance efficiency is desirable, accuracy of predictions and repeatability of task execution are more important for many businesses' long-term stability.

Third, the collected estimates and measured times can suggest whether expenditures in acquiring newer, more capable equipment, will improve productivity, to what degree additional worker training is likely to be beneficial, or whether there are simply not enough (or too many) resources.

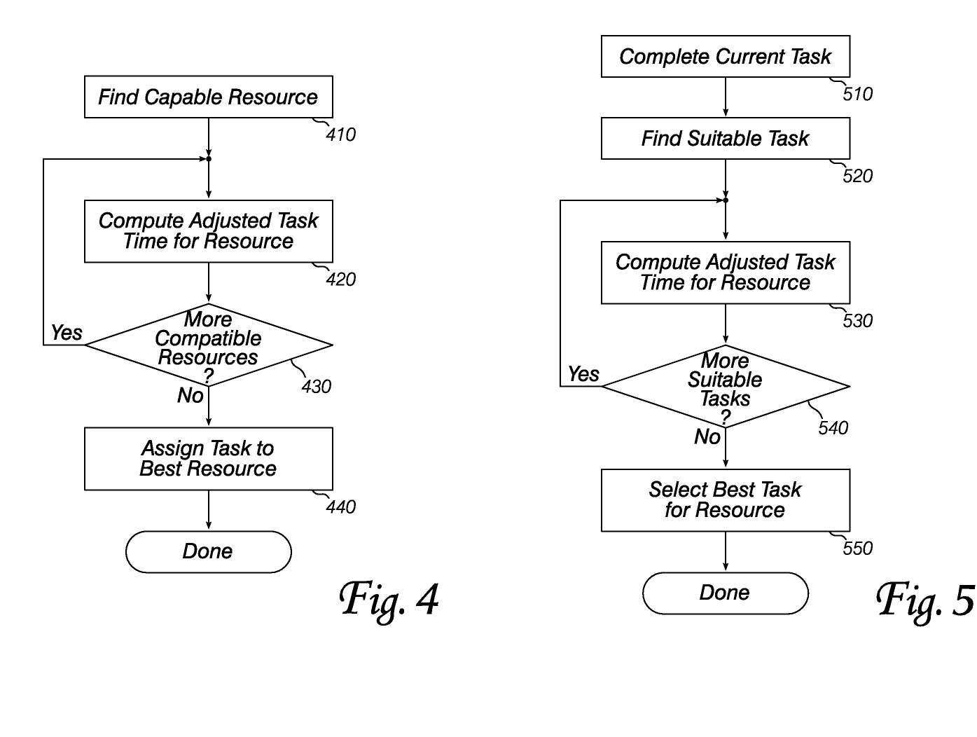

Adjusted task times can be applied in resource-centric and task-centric systems. FIG. 4 shows a task-centric method: when a scheduled task is to be performed, the system finds a resource that could perform it (410) and calculates an adjusted task time for that resource to execute the task (420). The adjusted task time may take into account the amount of time remaining in the resource's current task, the distance the resource would have to cover to reach the beginning location of the scheduled task, and similar factors. Then, if there are other resources that could also perform the task (“compatible resources”) (430), adjusted task times for those resources are also computed. Finally, the “best” resource is selected (440) and the task is assigned. (“Best” may mean the resource that can perform the task quickest, or with the least wasted movement, or whose adjusted task time most closely approximates the preliminary task estimate.) In a resource-centric system, when a resource completes its current task (510), a next potential task is chosen (520) and an adjusted task time for the resource to execute that task (530) is calculated. If there exist additional tasks could also be performed by the resource (540), adjusted task times for those tasks are also computed. Finally, the “best” task for the resource is selected (550).

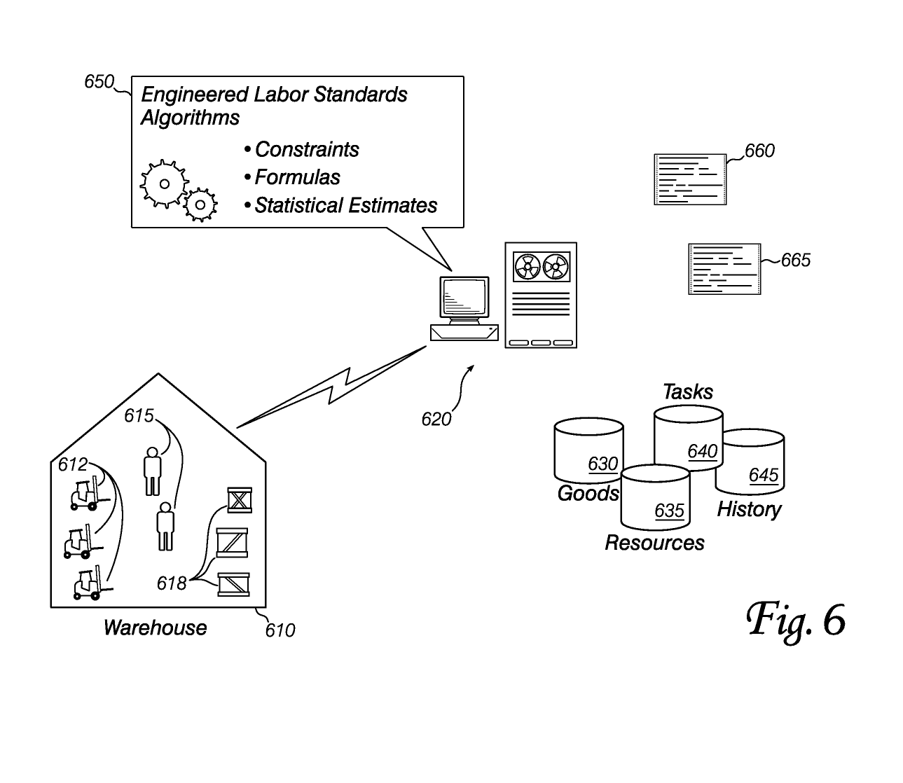

FIG. 6 shows some elements of a system that implements an embodiment of the invention. A warehouse 610 contains equipment 612, workers 615 and materials 618 (e.g., supplies, consumables, finished products). Information about the warehouse's contents may be collected manually, or through an automatic system such as a wireless (radio-based) identification and tracking system. This information is communicated to a management data processing system 620, where it is collated and stored with other information in various databases: goods 630, resources (i.e. workers and equipment, or autonomous equipment) 635, tasks 640 and historical data 645. Data processing system 620, executing hardware- and/or software-based engineered labor standards (“ELS”) algorithms 650, monitors and coordinates warehouse operations as described above, and produces reports 660, 665 based on the data collected. Reports may be in human-readable text form (e.g. an employee efficiency report for use in setting a worker's compensation or bonus incentive), or in a machine-readable form (a “data interchange” format) for transferring to another system where further analysis will be conducted.

Several features may be included in the ELS algorithms of an embodiment of the invention. Constraints permit estimated task execution times to be made more accurate by providing additional information for the ELS algorithm to consider. For example, a constraint may require that a particular worker or a particular class of resource be assigned to the task when it is executed. The system can then use historical data of that worker or resource class, rather than a more general default value, for predicting task times. Formulas may permit time-invariant information to be incorporated in task estimates. Through the use of formulas and constraints, an embodiment can be configured to prepare arbitrarily detailed task execution time estimates. Although FIG. 3A suggests that an estimate is made simply by adding up projected times for a sequence of steps, an estimate can also incorporate information such as the weight, size or volume of an item to be manipulated; whether the item is part of an aggregation that must be separated (e.g., a case of widgets may need to be opened to obtain the desired number of widgets); what type of packaging the item has (e.g., is it palletized, so that a fork lift can be used?); or a material group the item belongs to (e.g., is it fragile? Flammable? Perishable?) Factors such as these can influence an execution time estimate by increasing or decreasing a step time proportionately, rather than by supplying a fixed time component to be added into the estimate. Formulas may include Boolean logic statements and similar programmatic constructs so that a task time estimate can include calculations like “IF item to be moved is liquid or flammable, THEN increase transit time by 20%.” Statistical information derived from collected historical data may be used to prepare best-case, worst-case and estimates with selected degrees of confidence. Historical data may be fed back into the estimating process so that subsequent preliminary estimates are more accurate.

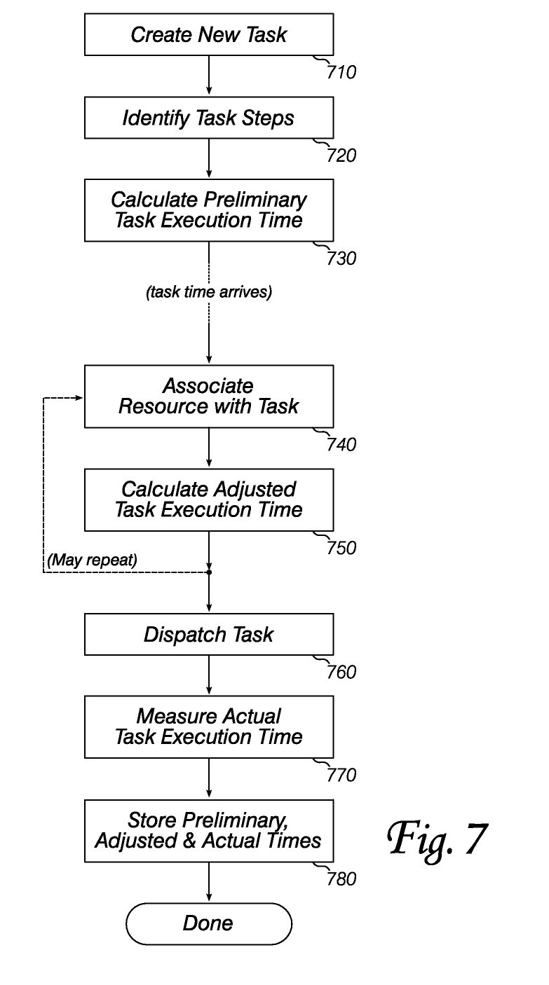

FIG. 7 is a flow chart outlining overall system operations in an environment like that depicted in FIG. 6. A new task (e.g. a warehouse order) is created in the system (710). An ELS algorithm identifies the different steps involved in executing the task (720) and calculates a preliminary estimated task time for the task (730). At this point, it may not be known which specific resource will do the job, and there is no information about the resource's previous location (i.e. the location where the resource finished its last task) or the resource's attributes (e.g. its velocity). To prepare the preliminary estimate, the system may use the attributes of the least-capable resource so that the estimate is a worst-case value, or it may use attributes derived statistically from historical data. In some embodiments, the values and parameters used for the preliminary estimated task time may be configurable, or may be set according to a deterministic formula. For example, a system operator may configure a first “pick” time estimate for items weighing less than 20 kg, and a second “pick” time estimate for items of 20 kg or heavier.

Later, when the task is due to be executed, a particular resource is associated with the task (740). At this time, the resource's attributes (velocity, operator experience level, etc.) are known, as are the resource's location and contemporaneous conditions that might affect the execution of the task. A second ELS algorithm computes the adjusted planned time based on the best-available data (750). The second algorithm may be the same as the first, but supplied with current information instead of estimates or defaults. As discussed in connection with FIGS. 4 and 5, operations 740 and 750 might be performed a number of times, either to find the best resource for a given task, or to find the best task for a given resource. The task is dispatched (760) and the actual task execution time is measured (770). Finally, the preliminary, adjusted, and actual task times are stored in a database (780) for subsequent analysis. The times need not be stored together, but they are logically related because they refer to a particular execution of a task by a particular resource, so they can be thought of as a “triplet” of data (the preliminary estimate, the adjusted estimate, and the actual execution time).

An embodiment of the invention may be a machine-readable medium having stored thereon instructions which cause a programmable processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing information in a form readable by a machine (e.g., a computer), including but not limited to Compact Disc Read-Only Memory (CD-ROM), Read-Only Memory (ROM), Random Access Memory (RAM), and Erasable Programmable Read-Only Memory (EPROM).

The applications of the present invention have been described largely by reference to specific examples and in terms of particular allocations of functionality to certain hardware and/or software components. However, those of skill in the art will recognize that task duration estimates of improved accuracy can also be made by software and hardware that distribute the functions of embodiments of this invention differently than herein described. Such variations and implementations are understood to be captured according to the following claims.

We claim:

1. A method comprising:
preparing a preliminary estimate of a task duration based on a subset of a plurality of conditions;
preparing an adjusted estimate of the task duration based on the plurality of conditions;
measuring an actual duration of the task; and
storing the preliminary estimate, the adjusted estimate and the actual duration in a database.

2. The method of claim 1 wherein the preliminary estimate, the adjusted estimate and the actual duration form an estimate-duration triplet, the method further comprising:
storing a plurality of additional estimate-duration triplets in the database; and
evaluating an accuracy of the preliminary estimate based on an average difference between adjusted estimates and corresponding actual durations.

3. The method of claim 1, further comprising:
preparing a plurality of adjusted estimates, each adjusted estimate corresponding to one of a plurality of resources that could perform the task; and
assigning the task to one of the plurality of resources based on the plurality of adjusted estimates.

4. The method of claim 1 wherein the plurality of conditions includes at least one of a weight of an item, a size of the item, a volume of the item, an aggregation quantity of the item, a packaging type of the item, a material group of the item, a source location or a destination location.

5. The method of claim 1 wherein the plurality of conditions includes a characteristic of a specific tool used to perform the task.

6. The method of claim 1, further comprising:
collecting a plurality of estimated and actual task performance times of a worker, wherein each of the plurality of estimated task performance times incorporates a condition that cannot be determined until performance of a task commences;
computing a worker efficiency based on a difference between corresponding pairs of estimated and actual performance times; and
adjusting a compensation of the worker according to the worker efficiency.

7. The method of claim 6 wherein the condition is one of a specific tool used to perform the task, a location of the worker at a beginning of the task or a set of concurrent tasks occurring where the task is to be performed.

8. A computer-readable medium containing data and instructions to cause a programmable processor to perform operations comprising:
preparing a preliminary estimate of a time required to perform a task;
refining the preliminary estimate based on a condition that was indefinite when the preliminary estimate was prepared, and became definite before the preliminary estimate was refined;
measuring an actual time required to perform the task; and
storing the refined preliminary estimate and the actual time in a database.

9. The computer-readable medium of claim 8 containing additional data and instructions to cause the programmable processor to perform operations comprising:
scheduling a task to be performed by a resource; and
identifying a plurality of steps of the task; wherein
preparing the preliminary estimate comprises calculating a sum of estimated times to complete each of the plurality of steps.

10. The computer-readable medium of claim 8 containing additional data and instructions to cause the programmable processor to perform operations comprising:
selecting one of a plurality of resources to perform the task based on a refined preliminary estimate prepared for each of the plurality of resources; and
dispatching the selected one of the plurality of resources to perform the task.

11. The computer-readable medium of claim 8 wherein the condition is one of a velocity of a resource to perform the task, a worker who is to perform the task, or an interference from a concurrent task.

12. A method comprising:
scheduling a task to be performed by an undetermined resource of a plurality of resources;
computing an estimated time for a hypothetical resource to complete the task, the estimated time computation omitting a unique characteristic of the undetermined resource and a situational characteristic of the undetermined resource;
computing an adjusted estimated time for a selected resource of the plurality of resources to complete the task, the adjusted estimated time computation including a unique characteristic of the selected resource and a situational characteristic of the selected resource;
assigning the task to the selected resource; and
measuring an actual time required for the selected resource to complete the task.

13. The method of claim 12 wherein the unique characteristic of the selected resource is a speed of the selected resource.

14. The method of claim 12 wherein the situational characteristic of the selected resource is a location of the selected resource before beginning the task.

15. The method of claim 12, further comprising:
computing an adjusted estimated time for each resource of the plurality of resources to complete the task, each adjusted estimated time computation including a unique characteristic of the corresponding resource and a situational characteristic of the corresponding resource.

16. An Engineered Labor Standards (“ELS”) scheduling system comprising:
a plurality of scheduled tasks;
a plurality of resources to execute the scheduled tasks; and
task estimation logic to estimate a time required to execute a task, wherein
the task estimation logic is to produce a preliminary estimate based on partial information before the task is to be executed; and
the task estimation logic is to produce an adjusted estimate based on complete information when the task is to be executed.

17. The ELS scheduling system of claim 16, further comprising:
task assignment logic to assign the task to one of the plurality of resources based on a plurality of adjusted estimates, wherein each of the plurality of adjusted estimates indicates an approximate time for a corresponding one of the plurality of resources to perform the task.

18. The ELS scheduling system of claim 17 wherein the task assignment logic is to select a best resource of the plurality of resources to perform the task.

19. The ELS scheduling system of claim 17 wherein the task assignment logic is to select a best task of the plurality of scheduled tasks to be assigned to a resource.
